(19) United States
(12) Patent Application Publication
(10) Pub. No.: US 2017/0363804 A1
(43) Pub. Date: Dec. 21, 2017

(54) MULTICORE FIBER HAVING ELLIPTICAL CORES

(71) Applicant: Corning Incorporated, Corning, NY (US)

(72) Inventors: Ming-Jun Li, Horseheads, NY (US); Jeffery Scott Stone, Addison, NY (US); Gaozhu Peng, Horseheads, NY (US)

(21) Appl. No.: 15/601,581

(22) Filed: May 22, 2017

Related U.S. Application Data
(60) Provisional application No. 62/350,825, filed on Jun. 16, 2016.

(51) Int. Cl. G02B 6/02

(52) U.S. Cl. CPC G02B 6/02042; G02B 6/02; G02B 6/02257

(57) ABSTRACT

A multicore fiber is provided that includes a plurality of elliptical cores spaced apart from one another. Each of the plurality of elliptical cores has an elliptical shape. The multicore fiber also includes a cladding surrounding the plurality of elliptical cores.

This application claims the benefit of priority under 35 U.S.C. §119 of U.S. Provisional Application Ser. No. 62/350,825 filed on Jun. 16, 2016 the content of which is relied upon and incorporated herein by reference in its entirety.

### BACKGROUND

This invention generally pertains to a multicore fiber that includes a cladding having a plurality of cores which are well suited for use with optical transmission systems using space division multiplexing (SDM) and enhanced signal carrying capacity with a single transmission fiber. Multicore optical fibers typically have round core elements for either single mode or multimode. The round core designs may be polarization sensitive and may experience high mode coupling in each mode group. Accordingly, it is desirable to provide for a multicore fiber that is less sensitive to polarization and high mode coupling.

### SUMMARY

In accordance with one embodiment, a multicore fiber is provided. The multicore fiber includes a plurality of elliptical cores spaced apart from one another. Each of the plurality of elliptical cores having an elliptical shape and a cladding surrounding the plurality of elliptical cores.

In accordance with another embodiment, a method of forming a multicore fiber having elliptical cores is provided. The method includes the steps of forming a preform having a plurality of elliptical core canes and cladding surrounding the core canes and inserting the preform in a draw furnace. The method also includes the step of drawing a multicore fiber from the preform to achieve a multicore fiber having a plurality of elliptical cores.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an end view of a multicore fiber having a plurality of elliptical cores, according to one embodiment;

FIG. 2 is an end view of a multicore fiber having eight elliptical cores arranged in a ring-shaped pattern with the major axes oriented horizontally, according to another embodiment;

FIG. 3 is an end view of a multicore fiber having eight elliptical cores arranged in a ring-shaped pattern with the major axes oriented radially, according to another embodiment;

FIG. 4 is an end view of a multicore fiber having six elliptical cores arranged in a ring-shaped pattern with the minor axes oriented radially, according to another embodiment;

FIG. 5 is an end view of a multicore fiber having eight elliptical cores arranged in a 2×4 array, according to another embodiment;

FIG. 6 is an end view of a multicore fiber having four equally spaced elliptical cores with the minor axes oriented radially, according to a further embodiment;

FIG. 7 is an end view of a rectangular multicore fiber having nine elliptical cores arranged in a linear array, according to another embodiment;

FIG. 8 is a graph illustrating the step-shaped and graded refractive index design profiles realizable by the elliptical cores for the multicore fiber;

FIG. 9 is a graph illustrating the refractive index design profile of one of the cores shown in FIG. 7;

FIGS. 10A-10D are schematic diagrams illustrating a process for making a preform that produces the multicore fiber with elliptical cores, according to one embodiment;

FIGS. 11A-11D are schematic views illustrating a process for making a preform that produces the multicore fiber with elliptical cores, according to another embodiment; and

FIG. 12 is a schematic diagram illustrating an optical fiber production system used for forming the multicore fiber having elliptical cores.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

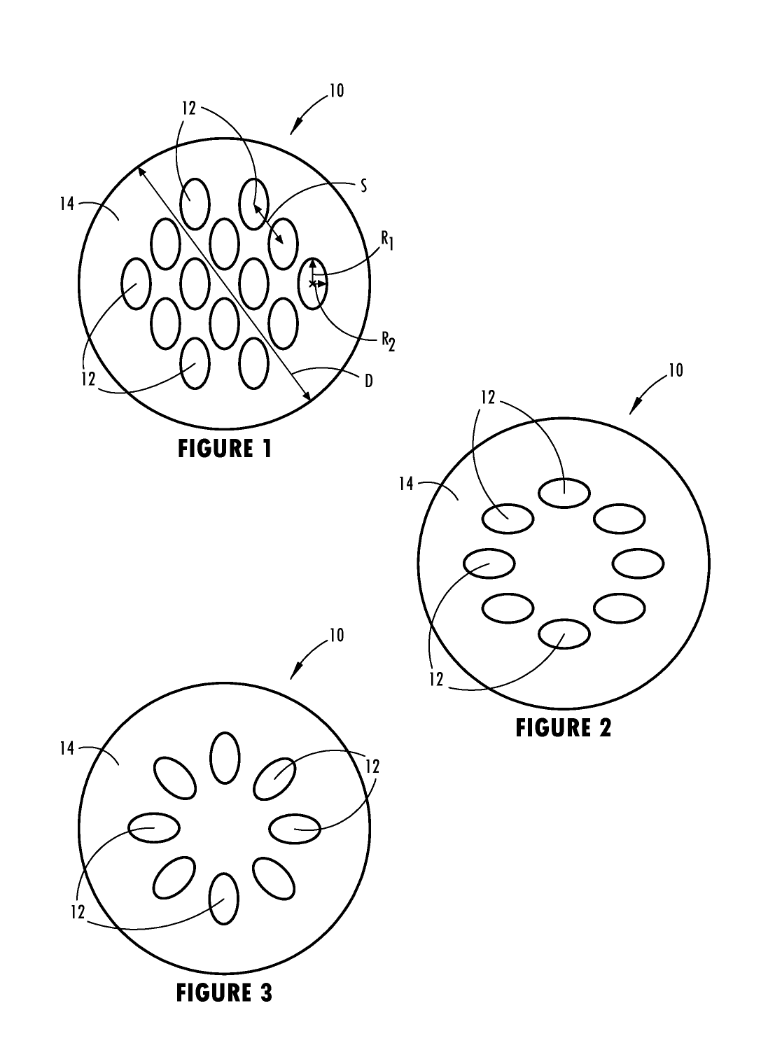

Referring to FIGS. 1-7, the terminal end of bare uncoated multicore fibers 10 having a plurality of elliptical cores 12 surrounded by a cladding 14 are illustrated, according to various embodiments. The plurality of elliptical cores 12 may be glass cores each having an elliptical shape in cross section and spaced apart from one another. The cladding 14 is shown having a generally circular end shape or cross-sectional shape in the embodiments illustrated in FIGS. 1-6 and a rectangular shape end shape or cross-sectional shape in the embodiment illustrated in FIG. 7. The elliptical cores 12 extend through the length of the fiber and are illustrated spaced apart from one another and separated by the cladding 14. Each fiber 10 contains at least two elliptical core elements and therefore has a plurality of elliptical cores. It should be appreciated that two or more elliptical core elements may be included in the multicore fiber 10 in various numbers of cores and various fiber arrangements. Each of the elliptical cores 12 has an elliptical or oval shape with an amount of ovality as described herein.

The multicore fiber 10 employs a plurality of glass cores 12 spaced from one another and surrounded by the cladding 14. The cores 12 and cladding 14 may be made of glass or other optical fiber material and may be doped suitable for optical fiber. In one embodiment, the shape of the multicore fiber 10 may be a circular end shape or cross-sectional shape as shown in FIG. 1. In other embodiments, the shape of the fiber 10 may be a square or rectangular end shape or cross-sectional shape as shown in FIG. 7. According to other embodiments, other non-circular cross-sectional shapes and sizes may be employed including hexagonal and various polygonal forms. The multicore fiber 10 includes a plurality of elliptical cores 12, each capable of communicating light signals between transceivers including transmitters and receivers which may allow for parallel processing of multiple signals. The multicore fiber 10 may be used for wavelength division multiplexing (WDM) or multi-level logic or for other parallel optics of spatial division multiplexing. The multicore fiber 10 may advantageously be aligned with and connected to various devices in a manner that allows for easy and reliable connection so that the plurality of cores 12 are aligned accurately at opposite terminal ends with like communication paths in connecting devices.

The multicore fiber 10 illustrated in FIG. 1 has fourteen (14) elliptical shaped cores 12 arranged in a circular area in an approximate triangular lattice arrangement and surrounded by a glass cladding 14. Each of the elliptical cores 12 has a major radius R₁ defined by the longest radius extending along the major axis and a minor radius R₂ defined by the shortest radius extending along the minor axis. The elliptical cores 12 illustrated in FIG. 1 are aligned in a common direction such that each of the major axes along the major radii R₁ of the elliptical cores 12 are aligned parallel to each other in the vertical direction. In addition, the adjacent elliptical cores 12 are spaced apart from each other by a distance S which is shown as a distance between the centers of adjacent cores 12. The cladding is also shown having a circular diameter D.

In FIG. 2, eight (8) elliptical cores 12 are illustrated arranged in a ring-shaped pattern within the cladding 14. Each of the cores 12 are oriented such that the major axes along the major radii R₁ are aligned in a common direction which is shown as the horizontal direction and the cores 12. The elliptical cores 12 are equally spaced within the ring shape pattern.

In FIG. 3, eight (8) elliptical cores 12 are shown arranged in a ring-shaped pattern within the cladding 14. Each of the elliptical cores 12 has the major axes along the major radius R₁ aligned in a radial direction extending from a center position of the cladding 14 radially outward. The elliptical cores 12 are evenly spaced within the ring shape pattern.

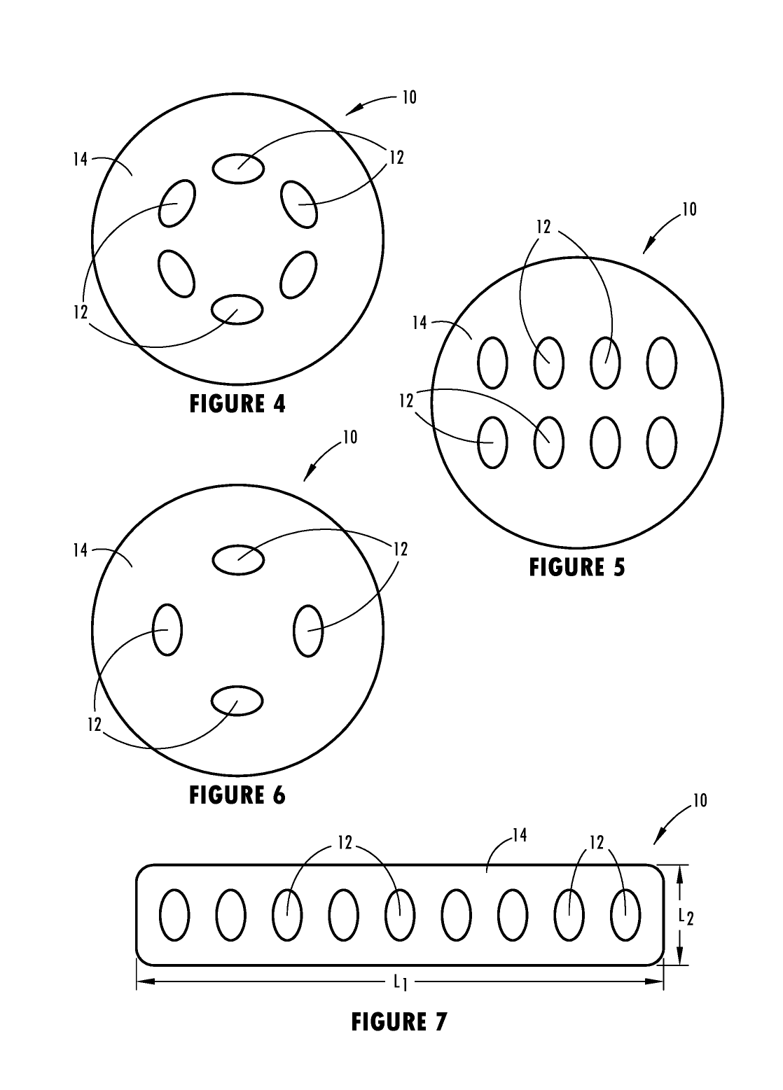

In FIG. 4, six (6) equally spaced elliptical cores 12 are illustrated in a generally ring-shaped pattern. Each of the elliptical cores has the minor axis along the minor radius R₂ aligned in a radial direction extending from the center position of the cladding radially outward. The elliptical cores 12 are evenly spaced within the ring-shaped pattern.

In FIG. 5, eight (8) elliptical cores 12 are shown arranged in a 2×4 array having four columns and two rows. Each of the elliptical cores 12 has a major axis along the major radius R₁ aligned in the same direction which is vertical direction in this example.

In FIG. 6, a multicore fiber 10 is illustrated having four (4) elliptical cores 12 equally spaced within cladding 14. The elliptical cores 12 are oriented such that the minor axes along the minor radii R₁ extend in the radial direction from the center position of the cladding radially outward.

In FIG. 7, the cladding 14 is illustrated having a generally rectangular shape. In this embodiment, nine elliptical cores 12 are arranged in a linear 1×9 array. Each of the elliptical cores 12 has a major axis along the major radius R₁ aligned in the same direction which is shown as the vertical direction. The cladding 14 has a width L₁ and a thickness L₂ which is less than the length L₁. However, it should be appreciated that other shapes and sizes of the cladding 14 and arrangements of the elliptical cores 12 may be presented within a multicore fiber 10, according to the disclosure presented herein.

In the embodiments shown in FIGS. 1-6, the cladding 14 has a generally round end shape or cross-sectional shape with diameter D. The cladding diameter D is preferably less than 500 micrometers to ensure that the multicore fiber 10 remains flexible. More preferably, the diameter D of the cladding 14 is less than 250 micrometers. In the embodiment shown in FIG. 7, the linear arrangement of multicore fibers with nine (9) cores 12 in a ribbon shape or rectangular shape cladding 14 is illustrated. For the ribbon shape cladding arrangement, the thickness L₂ of the ribbon is preferably less than 250 micrometers, or more preferably less than 125 micrometers to ensure the multicore fiber 10 is flexible. The width L₁ of the ribbon is preferably less than 1,000 micrometers, more preferably less than 500 micrometers. In the various embodiments, the spacings between two adjacent elliptical cores 12 is preferably greater than 20 micrometers to ensure low crosstalk between the cores, and more preferably greater than 30 micrometers.

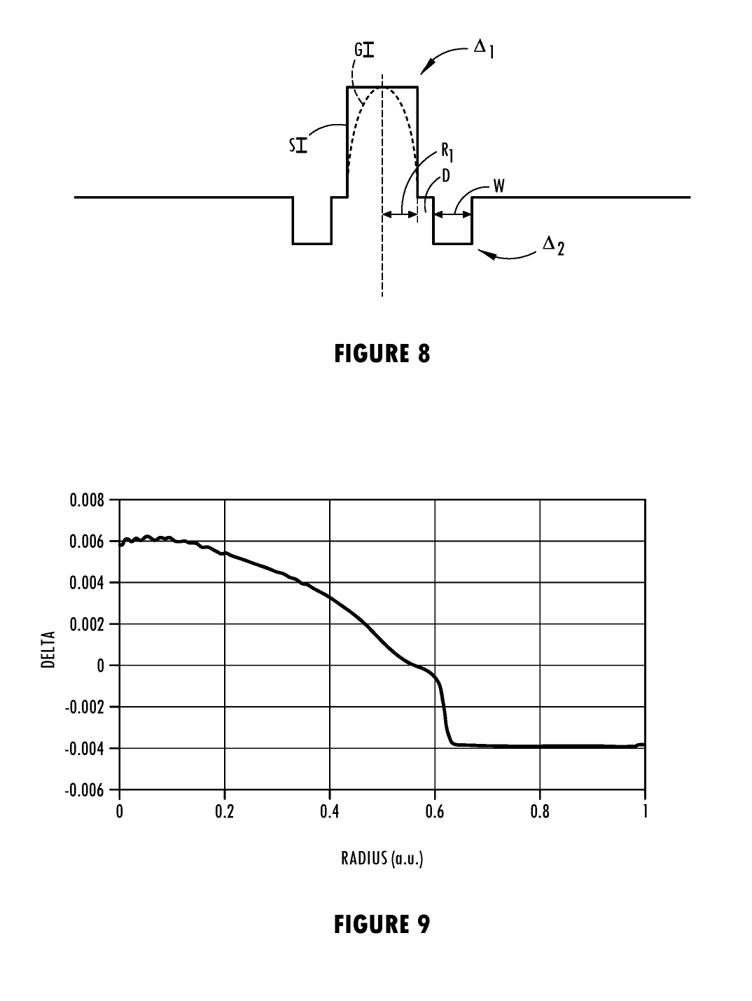

The elliptical cores 12 in the various multicore fibers 10 may have a simple step-shaped refractive index profile shown by line SI or a graded refractive index profile as shown by dashed line GI in FIG. 8. The refractive index profile is the relationship between the relative index percent (Δ %) and the optical fiber average core radius (as measured from the centerline of the core) over a selected segment of the fiber. A low index trench can also be placed in the cladding to increase light confinement in the core. The maximum index of the core n₁ is greater than the cladding index n_{c1}. Preferably, the relative refractive index of the core 12 to the cladding Δ₁ is greater than 0.2%, more preferably greater than 0.3%, and may be between 0.3 to 2.0%, according to one exemplary embodiment.

Each of the cores is elliptical in shape with a major radius R₁ and a minor radius R₂. The degree of ellipticity may be defined by an ovality parameter χ which may be defined by the following equation:

$$χ = \frac{{R}_{1} - {R}_{2}}{{R}_{0}}$$

where R₀ is the average core radius and may be defined by the following equation:

$${R}_{0} = \frac{{R}_{1} + {R}_{2}}{2}$$

The average core radius R₀ is in the range of two to fifteen micrometers (2-15 μm), and more preferably in the range of three to ten micrometers (3-10 μm), according to one embodiment. The elliptical core 12 can be single mode or multimode at an operating wavelength depending on the applications. Preferably, the ovality of the elliptical core 12 is more than 5%, more preferably more than 10%, and even more preferably greater than 20%. The low index trench may have a delta Δ₂ in the range of −0.7% to −0.1%, and a width W in the range of one to six micrometers (1-6 μm). The trench can be offset by a distance d from the core 12. The offset may be between zero to five micrometers (0-5 μm), according to one embodiment.

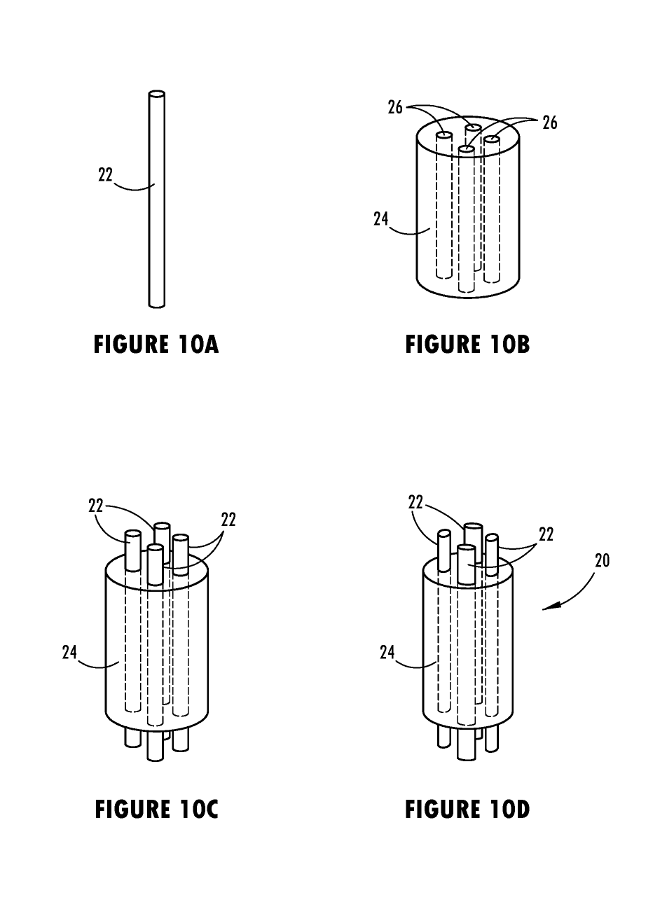

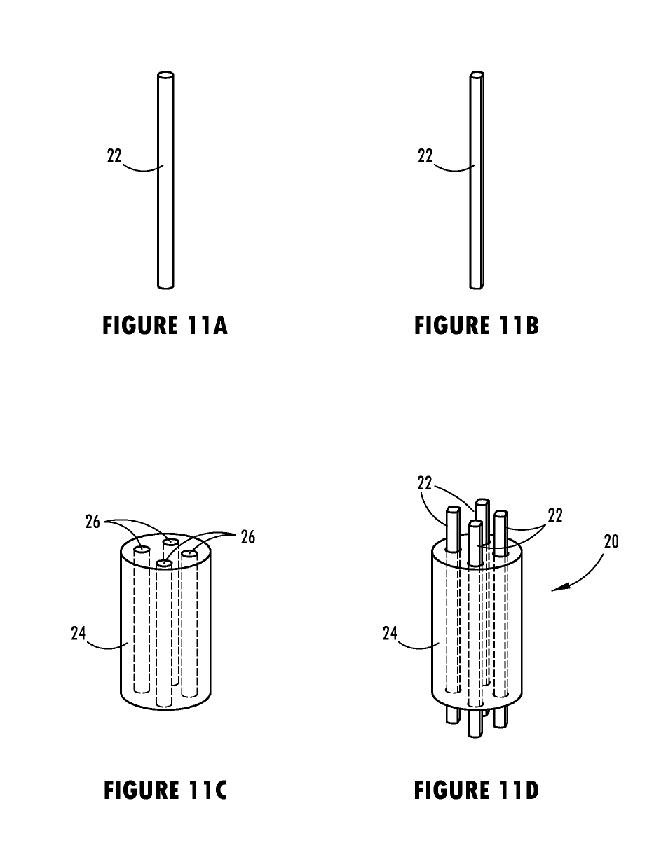

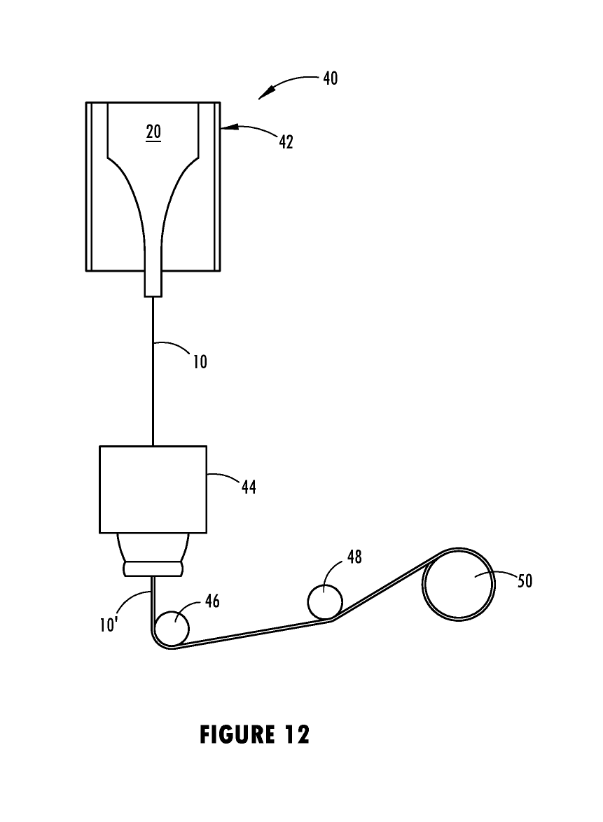

The multicore fiber 10 having elliptical cores 12 may be formed with the optical fiber production system 40 shown in FIG. 12 by drawing the fiber from a preform that may be made as shown in either of the embodiments shown in FIGS. 10A-10D or FIGS. 11A-11D. In the embodiment shown in FIGS. 10A-10D, the method of manufacturing the multicore fiber includes the step of forming a preform having a plurality of canes and a cladding glass surrounding the canes. The preform may be formed by providing a plurality of generally cylindrical starting canes which may be constructed of any glass or other optical fiber material and may be doped suitable for the manufacture of optical fiber. One example of a starting cane is illustrating in FIG. 10A. In the example shown, a total of four (4) round glass core canes are prepared. To make the core canes, a glass core preform may be made by a conventional glass preform making method, such as outside vapor deposition (OVD) and consolidation process. The core preform is redrawn into glass core canes with desired diameters. Next, a soot blank 24 is made by the OVD process, preferably with a soot density in the range of 0.8 to 1.2 g/cm². The soot blank is then drilled with holes 26 that extend through the soot blank 24 as seen in FIG. 10B. The holes 26 are formed are certain locations and with a diameter and spacing according to a multicore fiber design. The core canes 22 are inserted into the holes 26 of the soot blank 24 to form a soot glass cane assembly as shown in FIG. 10C. The soot glass cane assembly is sintered into a glass preform at a temperature of about 1450° C. in a He atmosphere. During the sintering process, the soot blank 24 shrinks in the radial direction and the shrinking force causes an asymmetric stress effect that deforms the core canes 22 in the radial direction thereby forming elliptical shaped core canes 22 as shown in FIG. 10D. The resulting preform 20 with elliptical core canes 22 is then heated in a draw furnace to form the multicore fiber.

Referring to FIGS. 11A-11D, another method of forming a preform 20 that produces elliptical cores is illustrated according to another embodiment. In this embodiment, round glass core canes are first made as shown in FIG. 11A. Next, the core canes 22 are trimmed on each side wall throughout the entire length to form an elongated shape having trimmed side walls that form a substantially elliptical cross section as shown in FIG. 11B. Next, a glass blank 24 is made by using the conventional OVD and consolidation process. The glass blank 24 is then drilled with holes 26 at certain locations and with the diameter and spacing according to a multicore fiber design as shown in FIG. 11C. Finally, the core canes 22 are inserted into the holes 26 to form a multicore preform 20 that may be heated in a draw furnace to form the multicore fiber.

The assembled preforms 20 shown in either FIG. 10D or 11D may be used to draw the multicore fiber having elliptical cores with a conventional fiber draw process employing the optical fiber production system 40 shown in FIG. 12, according to one embodiment. The optical fiber production system 40 is shown having a draw furnace that may be heated to a temperature of about 2000° C. The glass optical fiber preform 20 is placed in the draw furnace 42 where it is heated and multicore fiber 10 is drawn therefrom, as shown by the bare optical fiber 10 output exiting the bottom of the draw furnace 42. Once the bare optical fiber 10 is drawn from the preform 30, the bare optical fiber 10 may be cooled as it exits the bottom of the draw furnace 42. After sufficient cooling, the bare optical fiber 10 may be subjected to a coating unit 44 wherein a primary protective coating layer is applied to the outer surface of the bare optical fiber 10. After leaving the coating unit 44, the coated optical fiber 10′ with a protective layer can pass through a variety of processing stages within the production system 40, such as tractors or rollers 46 and 48 and onto a fiber storage spool 50. One of the rollers 46 or 48 may be used to provide the necessary tension in the optical fiber as it is drawn through the entire fiber production system and eventually wound onto the storage spool 50.

The preforms 20 shown in either of FIG. 10D or 11D are therefore exemplary of preforms that may be used to draw the multicore fiber 10 having four (4) elliptical cores 12 shown in FIG. 6. In doing so, the elliptical shaped canes 22 of the preform 20 are drawn into the elliptical shape cores 12 of the multicore fiber 10 such that the cross-sectional elliptical shape is substantially maintained. It should be appreciated that other shapes and sizes of the preform and other numbers of canes may be employed to achieve a multicore fiber having a plurality of elliptical cores, according to the various embodiments shown and described herein.

### Example

A multicore fiber 10 having four elliptical cores 12 equally spaced within a circular cross section cladding 14 was made according to the example shown in FIG. 6. A silica soot blank with 4800 g silica soot was prepared first by the outside vapor deposition (OVD) process. The post laydown soot density was 0.5 g/cm³. The diameter of the soot blank was 110 mm. A 30 cm long section of the soot blank was cut. To have adequate mechanical strength for drilling, the soot blank was pre-sintered at 1270° C. for three (3) hours in helium atmosphere to increase the density to about 1.0 g/cm³. After pre-sintering, the soot blank was drilled with four holes with 15 mm diameter equally spaced around the center of the soot blank with a spacing between the holes about 40 mm. A glass core preform was made and redrawn into core canes of 14 mm diameter. FIG. 9 shows the refracted index profile of the core canes. The core canes were made with Ge doping with an alpha profile with the alpha value around 2.0. The core delta was about 0.6%. A low index trench surrounded the core cane to reduce the bending loss and crosstalk between the core canes. The low index trench was made by F doping and the delta was about −0.4%. Four core canes were inserted into the four holes in the soot blank. The soot preform with four core canes was sintered into a glass preform with a normal sintering process at 1450° C. in a He atmosphere. During the sintering process, the core canes were deformed into an elliptical shape due to asymmetric stress effect. The preform was drawn into fiber at 125 micrometers diameter using a draw tower. The cores were arranged in a circular array about the optical fibers center. The separation between adjacent cores and the circular array was about 55 micrometers. Each core was elliptical and had approximately 17 micrometers and 19 micrometers major and minor diameters, respectively, or 8.5 micrometers and 9.5 micrometers major and minor radii, respectively. The ovality of the core was about 11%.

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. A multicore fiber comprising:
a plurality of elliptical cores spaced apart from one another, each of the plurality of elliptical cores having an elliptical shape; and
a cladding surrounding the plurality of elliptical cores.

2. The multicore fiber of claim 1, wherein each of the plurality of elliptical cores has an ovality of greater than 5%.

3. The multicore fiber of claim 1, wherein each of the plurality of elliptical cores has an ovality of greater than 10%.

4. The multicore fiber of claim 1, wherein each of the plurality of elliptical cores has an ovality of greater than 20%.

5. The multicore fiber of claim 1, wherein each of the plurality of elliptical cores has an average core radius in the range of 2 to 15 micrometers.

6. The multicore fiber of claim 1, wherein the elliptical cores are spaced apart from one another by greater than 20 micrometers.

7. The multicore fiber of claim 1, wherein each of the plurality of elliptical cores has a major axis along a major radius, and wherein the major axis of each of the plurality of elliptical cores is aligned in the same direction.

8. The multicore fiber of claim 1, wherein the plurality of elliptical cores is arranged substantially in a ring.

9. The multicore fiber of claim 1, wherein each of the plurality of elliptical cores has a major axis along a major radius, and wherein the major axis of each of the plurality of elliptical cores is arranged in a radial direction from a center of the fiber.

10. The multicore fiber of claim 1, wherein the cladding is substantially circular in cross section.

11. The multicore fiber of claim 1, wherein the cladding is non-circular in cross section.

12. The multicore fiber of claim 11, wherein the cladding is substantially rectangular.

13. A method of forming a multicore fiber having elliptical cores, the method comprising the steps of:
forming a preform having a plurality of elliptical core canes and cladding surrounding the core canes;
inserting the preform in a draw furnace; and
drawing a multicore fiber from the preform to achieve a multicore fiber having a plurality of elliptical cores.

14. The method of claim 13, wherein the step of forming the preform comprises sintering the preform and applying asymmetric stress to the preform to cause the core canes to deform into an elliptical shape.

15. The method of claim 13, wherein the step of forming the preform comprises forming a plurality of core canes each having a substantially elliptical shape in cross section and locating the core canes in a blank.

16. The method of claim 13, wherein each of the plurality of elliptical cores has an ovality of greater than 5%.

17. The method of claim 13, wherein each of the plurality of elliptical cores has an ovality of greater than 10%.

18. The method of claim 13, wherein each of the plurality of elliptical cores has an ovality of greater than 20%.

19. The method of claim 13, wherein the cladding is substantially circular in cross section.

20. The method of claim 13, wherein the cladding is non-circular in cross section.
